(19) United States
(12) Patent Application Publication
(10) Pub. No.: US 2009/0307193 A1
(43) Pub. Date: Dec. 10, 2009

(54) Testing File System Semantic Parity

(75) Inventors: Raja S. Ganjikunta, Bellevue, WA (US); Blaine R. Young, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/136,758

(22) Filed: Jun. 10, 2008

(51) Int. Cl. G06F 13/00; G06F 17/30

(52) U.S. Cl. 707/3; 719/321; 707/E17.014

(57) ABSTRACT

Aspects of the subject matter described herein relate to testing filters for semantic parity. In aspects, a parity filter receives a request directed to a base file system. In response, the parity filter creates a semantically similar request to send to a tested file system. The parity filter then sends the requests to drivers associated with the file systems and receives responses thereto. The parity filter then compares the responses to determine if they are semantically equivalent. If they are different, the parity filter writes a log entry to a log. The parity filter may also directly or indirectly compare the two file systems associated with the drivers for semantic equivalency.

### BACKGROUND

When creating a new device driver, it is helpful to determine whether the new device driver handles data I/Os appropriately. For example, when creating a new version of a file system driver, it may be helpful to know that the new version handles I/O requests the same as the old version handled them so that applications that rely on the old version of the file system driver do not break when using the new version of the file system driver. Unfortunately, formulating and writing tests to detect data errors for device drivers may be involved and difficult.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to testing filters for semantic parity. In aspects, a parity filter receives a request directed to a base file system. In response, the parity filter creates a semantically similar request to send to a tested file system. The parity filter then sends the requests to drivers associated with the file systems and receives responses thereto. The parity filter then compares the responses to determine if they are semantically equivalent. If they are different, the parity filter writes a log entry to a log. The parity filter may also directly or indirectly compare the two file systems associated with the drivers for semantic equivalency.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary arrangement of components of a system that may operate in accordance with aspects of the subject matter described herein;

FIG. 3 is a block diagram representing another exemplary arrangement of components of a system that may operate in accordance with aspects of the subject matter described herein;

FIG. 4 is a block diagram representing another exemplary arrangement of components of a system that may operate in accordance with aspects of the subject matter described herein; and

FIG. 5 is a block diagram representing an exemplary arrangement of components of a system that operates in accordance with aspects of the subject matter described herein; and

FIG. 6 is a flow diagram that generally represents actions that may occur in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise.

### Exemplary Operating Environment

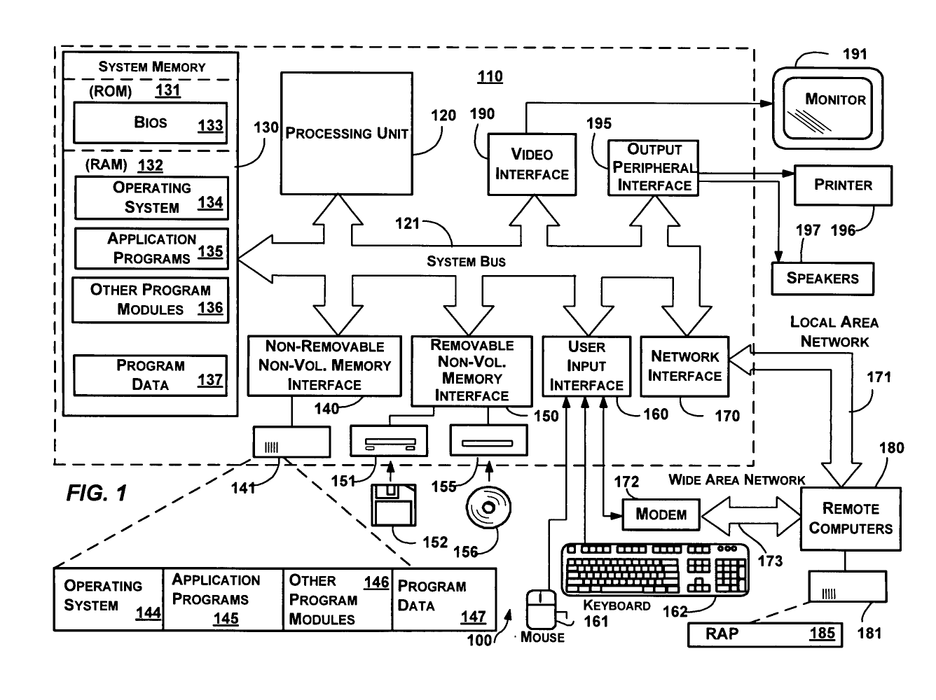

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 20 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Filters

With contemporary operating systems, such as Microsoft Corporation's Windows Vista operating system with an underlying file system such as the Windows® NTFS (Windows® NT File System), FAT, CDFS, SMB redirector file system, or WebDav file systems, one or more file system filter drivers may be inserted between the I/O manager that receives user I/O requests and the file system driver. In general, filter drivers (sometimes referred to herein simply as “filters”) are processes that enhance the underlying file system by performing various file-related computing tasks that users desire, including tasks such as passing file system I/O (requests and data) through anti-virus software, file system quota monitors, file replicators, and encryption/compression products.

For example, antivirus products provide a filter that watches I/O to and from certain file types (.exe, .doc, and the like) looking for virus signatures, while file replication products perform file system-level mirroring. Other types of file system filter drivers are directed to system restoration (which backs up system files when changes are about to be made so that the user can return to the original state), disk quota enforcement, backup of open files, undeletion of deleted files, encryption of files, and so forth. Thus, by installing file system filter drivers, computer users can select the file system features they want and need, in a manner that enables upgrades, replacement, insertion, and removal of the components without changing the actual operating system or file system driver code.

The term “process” and its variants as used herein may include one or more traditional processes, threads, components, libraries, objects that perform tasks, and the like. A process may be implemented in hardware, software, or a combination of hardware and software. In an embodiment, a process is any mechanism, however called, capable of or used in performing an action. A process may be distributed over multiple devices or a single device. In one embodiment, an entity comprises a process as defined above. In another embodiment, an entity comprises any one or more objects that is/are capable of performing actions associated with or using or one or more processes.

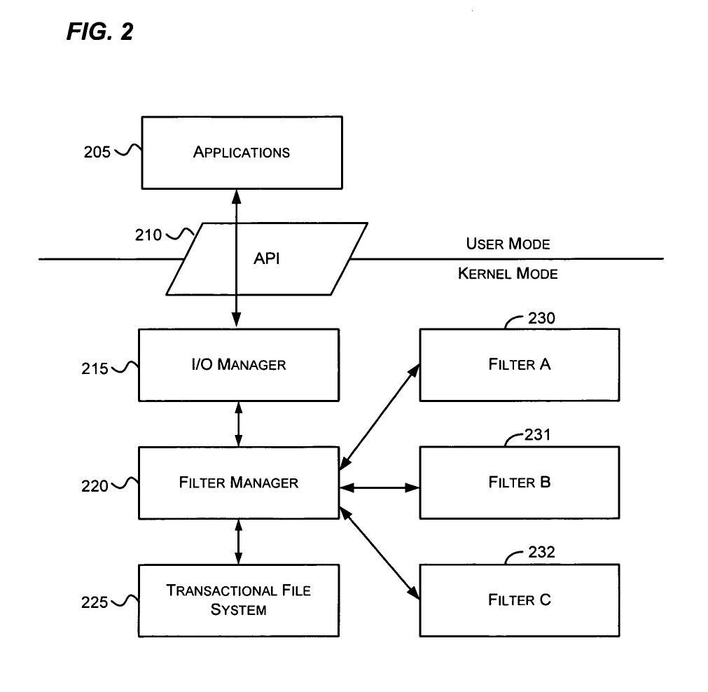

FIG. 2 is a block diagram representing an exemplary arrangement of components of a system that may operate in accordance with aspects of the subject matter described herein. The components include one or more applications 205, an applications programming interface (API) 210, an input/output (I/O) manager 215, a filter manger 220, a file system 225, and one or more filters 230-232.

The applications 205 may make file system requests (e.g., via function/method calls) through the API 210 to the I/O manager 215. The I/O manager 215 may determine what I/O request or requests to issued to fulfill each request and send each I/O request to the filter manager 220. The I/O manager 215 may also return data to the applications 205 as operations associated with the file system requests proceed, complete, or abort.

In one implementation, filters comprise objects or the like that when instantiated register (e.g., during their initialization procedure) with a registration mechanism in the filter manager 220. For efficiency, a filter may register for file system requests in which it may be interested in processing. To this end, as part of registration, each filter notifies the filter manager 220 of the types of I/O requests in which it is interested (e.g., create, read, write, close, rename, and so forth). For example, an encryption filter may register for read and write I/Os, but not for others wherein data does not need to be encrypted or decrypted. Similarly, a quota filter may be interested only in object creates, object deletes, object writes, and other operations that may cause on-disk allocation change of a file.

In addition to specifying the types of I/O requests in which it is interested, a filter may further specify whether the filter should be notified for pre-callbacks and post-callbacks for each of the types of I/O. A pre-callback is called as data associated with an I/O request propagates from the I/O manager 215 towards the file system 225, while a post-callback is called during the completion of the I/O request as data associated with the I/O request propagates from the file system 225 towards the I/O manager 215.

From each I/O request, the filter manager 220 may create a data structure in a uniform format suitable for use by the filters 230-232. Hereinafter, this data structure is sometimes referred to as callback data. The filter manager 220 may then call and pass the callback data to each filter that has registered to receive callbacks for the type of I/O received by the filter manager 220. Filters registered to receive callbacks for the type of I/Os received by the filter manager are sometimes referred to as mini filters.

The filter manager 220 may pass callback data associated with a particular type of I/O request to each registered filter sequentially in an order in which the registered filters are ordered. For example, if the filters 230 and 232 are registered to receive callbacks for all read I/O requests and are ordered such that the filter 230 is before the filter 232 in processing such requests, then after receiving a read I/O, the filter manager 220 may first call and pass the callback data to the filter 230 and after the filter 230 has processed the callback data, the filter manager 220 may then call and pass the callback data (as modified, if at all) to the filter 232.

A filter may be attached to one or more volumes. That is, a filter may be registered to be called and receive callback data for I/Os related to only one or more than one volumes.

A filter may generate its own I/O request which may then be passed to other filters. For example, an anti-virus filter may wish to read a file before it is opened. A filter may stop an I/O request from propagating further and may instruct the filter manager to report a status code (e.g., success or failure) for the I/O request. A filter may store data in memory and persist this data on disk. In general, a filter may be created to perform any set of actions that may be performed by a kernel-mode or user-mode process and may be reactive (e.g., wait until it receives I/O requests before acting) and/or proactive (e.g., initiate its own I/O requests or perform other actions asynchronously with I/O requests handled by the I/O manager 215).

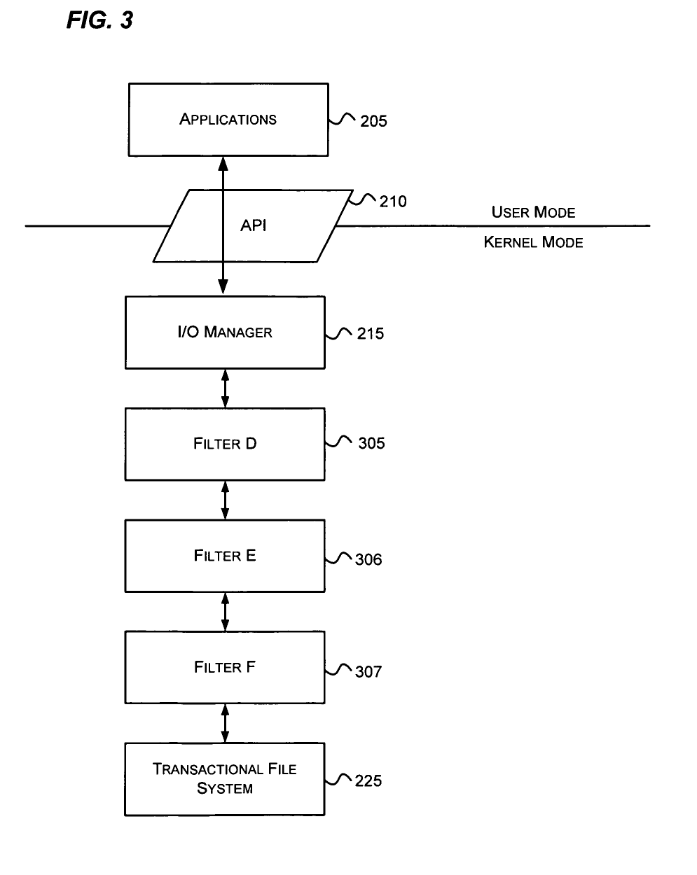

In one embodiment, filters may be arranged in a stacked manner as illustrated in FIG. 3, which is a block diagram representing another exemplary arrangement of components of a system that may operate in accordance with aspects of the subject matter described herein. In this embodiment, each of the filters 305-307 may process I/O requests and pass the requests (modified or unmodified) to another filter or other component in the stack. For example, in response to a read request received from one of the applications 205, the I/O manager 215 may issue an I/O request and send this request to the filter 305. The filter 305 may examine the I/O request and determine that the filter 305 is not interested in the I/O request and then pass the I/O request unchanged to the filter 306. The filter 306 may determine that the filter 306 will perform some action based on the I/O request and may then pass the I/O request (changed or unchanged) to the filter 307. The filter 307 may determine that the filter 307 is not interested in the I/O request and pass the I/O request to the file system 225. The file system 225 may operate on one or more volumes that may be located locally or remotely to the machine or machines upon which the applications 205 execute

After the file system 225 services the I/O request, it passes the results to the filter 307. Typically, the results pass in an order reverse from that in which the I/O request proceeded (e.g., first to filter 307, then to filter 306, and then to filter 305). Each of the filters 305-307 may examine the results, determine whether the filter is interested in the results, and may perform actions based thereon before passing the results (changed or unchanged) on to another filter or component.

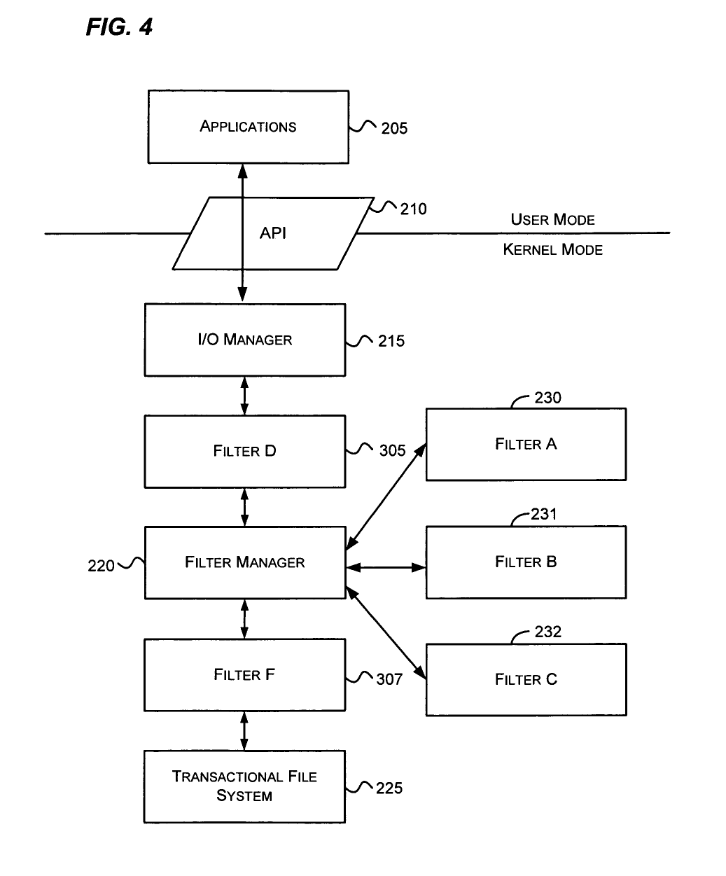

In another embodiment, filters may be arranged in a stacked/managed manner as illustrated in FIG. 4, which is a block diagram representing another exemplary arrangement of components of a system that may operate in accordance with aspects of the subject matter described herein. In this configuration, some filters are associated with a filter manager while other filters are not. Filters that are associated with a filter manager (e.g., filters 230-232) are sometimes referred to herein as mini filters while filters that are not associated with a filter manager (e.g., filters 305 and 307) are sometimes referred to herein as legacy filters. The filter manager 220 is placed in a stack with other filters (e.g., filters 305 and 307).

It will be readily recognized that filters may be implemented in many other configurations without departing from the spirit or scope of aspects of the subject matter described herein. In some embodiments, a filter comprises any object that is given an opportunity to examine I/O between an application and a file system and that is capable of changing, completing, or aborting the I/O or performing other actions based thereon.

### Parity Tester

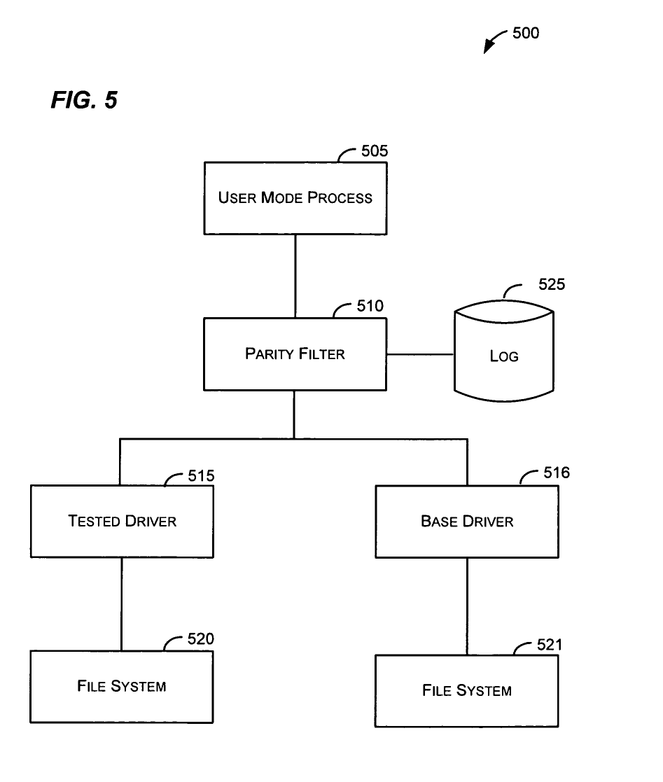

As mentioned previously, when creating a new device driver, it may be helpful to determine whether the new device driver handles data I/Os appropriately. FIG. 5 is a block diagram representing an exemplary arrangement of components of a system that operates in accordance with aspects of the subject matter described herein. The components illustrated in FIG. 5 are exemplary and are not meant to be all-inclusive of components that may be needed or included. In other embodiments, the components and/or functions described in conjunction with FIG. 5 may be included in other components (shown or not shown) or placed in subcomponents without departing from the spirit or scope of aspects of the subject matter described herein. The components of the system 500 may be included on a single apparatus (e.g., the computer 110 of FIG. 1) or may be distributed across two or more apparatuses. As illustrated in FIG. 5, the system 500 includes a user mode process 505, a parity filter 510, a tested driver 515, a base driver 516, and file systems 520-521.

The parity filter 510, drivers 515-516, and file systems 520-521 may comprise filters as has been described previously. In operation, the parity filter 510 may be configured to monitor a particular folder or volume for I/O requests. Hereinafter, the term folder is sometimes used to describe aspects of the subject matter described herein, but in other embodiments, each time the term “folder” is used the term “volume” is to be substituted therefor.

Logically, the tested driver 515 and the base driver 516 are in different filter stacks. Physically, however, the drivers 515 and 516 may be in the same filter stack or in different filter stacks without departing from the spirit or scope of aspects of the subject matter described herein.

The drivers 515 and 516 may comprise various types of filters including a virtual file system filter, a hierarchical storage management (HSM) filter, an encryption filter, a compression filter, an anti-malware filter, a filter that logs activity with the file system, a reparse filter, another type of filter, and the like.

The file systems 520 and 521 comprise one or more components that provide access to data on a data store. Access as used herein may include reading data, writing data, deleting data, updating data, a combination including one or more of the above, and the like. The term data is to be read broadly to include anything that may be stored on a computer storage medium. Some examples of data include information, program code, program state, program data, other data, and the like.

A data store may comprise any storage media capable of storing data. For example, a data store may comprise non-volatile memory such as a hard disk, volatile memory such as RAM, other storage media described in conjunction with FIG. 1, other storage, some combination of the above, and the like and may be distributed across multiple devices. The data store may be external, internal, or include components that are both internal and external to a device hosting the entities illustrated in FIG. 5.

In one embodiment, the file systems 520 and 521 may be stored on the same volume. In another embodiment, the file systems 520 and 521 may be stored in separate volumes. In one embodiment, the drivers 515-516 may be used to test a new version of a file system driver, wherein the base driver 516 may correspond to an old version of the file system while the tested driver 515 may correspond to a new version of the file system.

The parity filter 510 comprises a filter that may be used to detect data errors or operation errors between the test driver 515 and the base driver 516. Some exemplary data errors include data loss, data corruption, and data consistency errors and the like. Some exemplary operation errors include results of an I/O operation such as the result status, error code, result data, any effect/side-effect of an operation such change in request level, and/or any changes to the request and its callback data. The lists of errors above are not intended to be all-inclusive or exhaustive. Based on the teachings herein, those skilled in the art may recognize other errors to which aspects of the subject matter described herein may be applied.

When the parity filter 510 receives an I/O request associated with a monitored folder, the parity filter 510 creates a new I/O request that is semantically similar to the received I/O request but structured for use with the tested driver 515. “Semantically similar” in this context means that the new I/O request is formatted in an appropriate manner for the tested driver 515 to obtain the same or similar result, if available, as the base driver would with the file system 521 except with the file system 520. For example, the tested driver 515 may support a first set of file operations while the base driver 516 may support a second set of file operations that may have some differences from the first set of file operations. In this case, the parity filter 510 may map an I/O request directed to the base driver 516 to an equivalent or similar I/O request, if available, of the tested driver 515. The received I/O request is sent to the base driver 516 while the new I/O request is sent to the tested driver 515.

The parity filter 510 may be used with file systems that support transactions. In such environments, the new I/O request created by the parity filter 510 may be made part of the current transaction

Some time after the parity filter 510 has sent the I/O requests to the respective drivers, each of the drivers may send a response including callback data to the parity filter 510 indicating the result of a file operation executed in response to the request. For example, the result may indicate that a file operation succeeded, partially succeeded, or failed and may provide additional information. This additional information may include a timestamp of a file affected by the operation, bytes written in the operation, one or more error codes associated with the operation, other information, and the like.

The parity filter 510 may then compare the results to determine whether they are semantically equivalent. Results may include status or return codes and may also include other data (e.g., callback data) associated with the result. In determining whether they are semantically equivalent, the parity filter 510 may ignore certain data in the results. For example, the timestamps at which two file operations occur on the file systems 520 and 521 may not be the same and this data may be ignored by the parity filter 510. To determine whether the results are equal, the parity filter 510 may compare data in the two results in accordance with a pre-defined set of properties (e.g., data values within the two results). The properties that are included in the comparison set may be indicated via a configuration file (e.g., XML) and may vary depending on the type of I/O request.

If the parity filter 510 determines that the results are not semantically equivalent, the parity filter 510 may enter a log entry in the log 525. The log entry may include an indication of the I/O request together with information that indicates the differences between the results.

The parity filter 510 may have many concurrent outstanding I/O requests for which it has not received responses. To match responses from the drivers 515-516 appropriately, the parity filter 510 may associate an identifier with an I/O request sent to the base driver 516 and the semantic equivalent of the I/O request sent to the tested driver 515. The identifier may be placed in stream contexts or other data structures that are associated with the I/O requests.

When the parity filter 510 receives a response from a driver, it may obtain the stream context associated with the response and retrieve the identifier. Using the identifier, the parity filter 510 may then search a data structure to determine if the corresponding response has already been received from the other driver. If not, the parity filter 510 may store the response (or data derived therefrom) in the data structure together with the identifier in anticipation of receiving a response from the other driver. When both drivers have provided a response and the parity filter 510 has performed a comparison, the parity filter 510 may purge the data structure of the data associated with the identifier.

In addition to comparing responses from the two drivers 515-516, the parity filter 510 may also compare data on the two file systems 520-521. The data may be compared to see if it is semantically equivalent. This may be performed as an added check to ensure that the tested driver 515 is writing data appropriately to the file system 520. Before this type of comparison is done, the two file systems may be initialized to semantically the same initial state. For example, the file systems may be formatted and have all their files deleted and then one or more applications may be installed by sending requests to the parity filter 510 which may then be forked into requests that go to the tested driver 515 and the base driver 516 to initialize the file systems 520 and 521, respectively.

After this initialization, additional requests may be received by the parity filter 510 which may then send corresponding requests to the tested driver 515 and the base driver 516. At some point or periodically, the parity filter 510 may compare the data on the two file systems 520 and 521 to determine if it is semantically equivalent.

In some cases, the parity filter 510 may need to use the tested driver 515 or the base driver 516 to determine the contents of the file system 520 and the file system 521, respectively. For example, when the tested driver 515 encrypts/decrypts, compresses/decompresses, or otherwise transforms data, the parity filter 510 may need to use the tested driver 515 or the base driver 516 to compare the data on the file system 520 with the data on the file system 521.

If the tested driver 515 implements a file system capable of reparse points, the parity filter 510 may perform various operations to determine whether data on the file system 520 is semantically equivalent to data on the file system 521. A reparse point is a special file object with a reparse tag and data. When accessed, a reparse point is routed by the file system to a filter that handles the reparse point. A reparse point allows a file system to perform custom processing based on the data found in the reparse point. A reparse point may allow linking a file object transparently to an object within a container or remote storage so that to applications, the file appears to reside locally, for example. In one embodiment, when a reparse point is encountered in file system 520 that corresponds to a file in the file system 521, the name and possibly the date of the reparse point may be compared with the file.

In another embodiment, the tested driver 515 may be kept operational when comparing reparse points on the file system 520 to files on the file system 521. In this embodiment, the tested driver 515 may obtain data as appropriate for a reparse point and pass this to the parity filter 510, which may then compare the data with a corresponding file on the file system 521.

In yet another embodiment, data corresponding to the reparse point may be used to replace the reparse point prior to comparing the two file systems 520-521. In this embodiment, the tested driver 515 is not needed during the comparison of files.

In some embodiments, when dealing with reparse point, at setup time the parity filter 510 may scan the two file systems 520 and 521 for any file names that match. For these files, the parity filter 510 may save the file IDs and map the two files to each other. This may be done to be able to handle requests that open by fileID. In addition, handle mapping may also be maintained so that the parity filter 510 is able to handle operations based on FileHandle.

For comparison, a flag may be set that indicates whether read-buffers are to be compared when comparing responses from the two drivers 515-516. If the flag is not set, status/return codes may be checked without checking additional data. If the flag is set, however, additional data including read-buffers may also be compared when comparing responses from the two drivers 515-516.

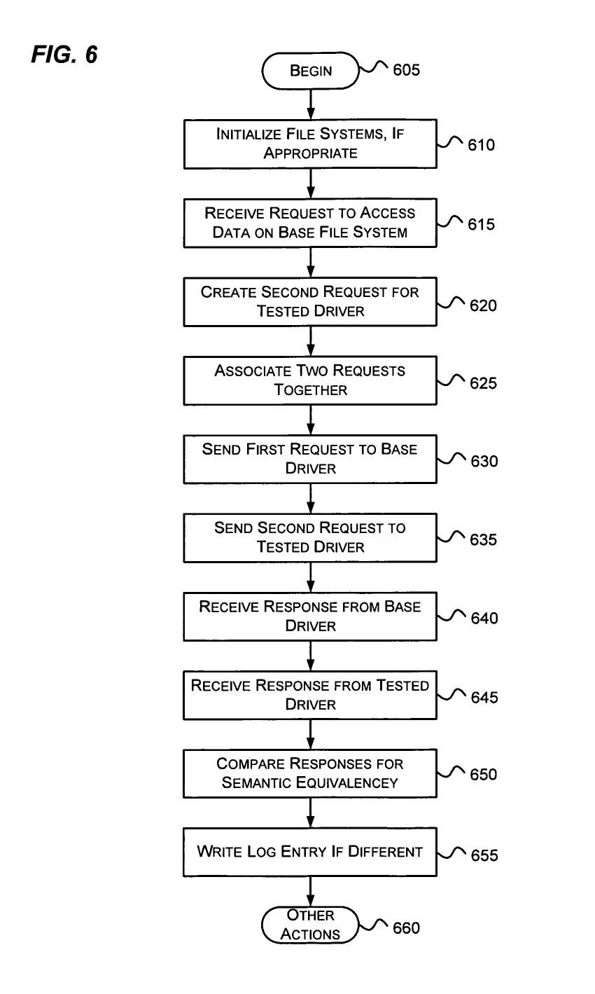

FIG. 6 is a flow diagram that generally represents actions that may occur in accordance with aspects of the subject matter described herein. For simplicity of explanation, the methodology described in conjunction with FIG. 6 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 6, at block 605, the actions begin. At block 610, the file systems are initialized, if appropriate. For example, referring to FIG. 5, the parity filter 510 may initialize (or cause to be initialized) the file systems 520-521. For example, it may be appropriate to initialize the file systems if testing the driver will involve comparing data on the file systems. It may also be appropriate to initialize the file systems even if testing the driver will only involve comparing status/return codes. Initializing the file systems may not be appropriate if they are already initialized or in other circumstances, for example. As an alternative to initializing the file systems, a filter may be initialized with knowledge about the differences in starting state of the two file systems.

At block 615, a request to access data on the base file system is received. For example, referring to FIG. 5, the user mode process 505 sends a request to access data on the file system 521. This request is received by the parity filter 510.

At block 620, a second request is created based on the first request and a targeted driver. For example, referring to FIG. 5, the parity filter 510 creates a second request to send to the tested driver 515.

At block 625, the two requests are associated together. For example, referring to FIG. 5, the parity filter 510 creates an identifier and places the identifier in one or more data structures associated with the requests so that when responses to the requests are received they may be matched together.

At block 630, the first request is sent to the base driver. For example, referring to FIG. 5, the parity filter 510 sends the original request to the base driver 516.

At block 635, the second request is sent to the tested driver. For example, referring to FIG. 5, the parity filter 510 sends the created request to the tested driver 515.

At block 640, a response is received from the base driver. For example, referring to FIG. 5, the parity filter 510 receives a response to the original request from the base driver 516.

At block 645, a response is received from the tested driver. For example, referring to FIG. 5, the parity filter receives a response to the created request from the tested driver 515.

Note that there is no intention that the order of the actions will always or even most often occur in the order indicated by blocks 630-645. Indeed, the actions may be ordered in almost any order without departing from the spirit or scope of aspects of the subject matter described herein.

At block 650, the responses are compared for semantic equivalency. For example, referring to FIG. 510, the parity filter may compare status/return codes and may also compares a set of fields within the responses to determine semantic equivalency.

At block 655, a log entry is written if the responses are semantically different. For example, referring to FIG. 5, if the base driver 516 reports success while the tested driver 515 reports failure, the parity filter writes a log entry to the log 525.

Semantic differences may impact future operations. For example, if one filter is able to create a file and another is not able to create the file, the one that was unable to create the file may not be able to rename the file, delete the file, and so forth.

At block 660, other actions, if any, may occur. Note that actions described in conjunction with FIG. 6 may occur in parallel as additional requests may be received by a parity filter while the parity filter is processing one or more requests.

As can be seen from the foregoing detailed description, aspects have been described related to testing filters for semantic parity. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
receiving a first request to access data of a first file system;
creating a second request, the second request being semantically similar to the first request;
sending the first request to a first driver associated with the first file system;
sending the second request to a second driver associated with a second file system;
receiving a first response to the first request from the first driver;
receiving a second response to the second request from the second driver; and
comparing the first and second responses.

2. The method of claim 1, wherein receiving a first request to access data of the first file system comprises receiving the first request at a component that has an opportunity to examine input to and output from the first and second file systems.

3. The method of claim 2, wherein the component comprises a filter.

4. The method of claim 1, wherein the first file system and the second file system reside on different volumes.

5. The method of claim 1, wherein comparing the first and second responses comprises ignoring certain data within the responses.

6. The method of claim 5, wherein the certain data comprises a timestamp that indicates when a file system was accessed.

7. The method of claim 1, further comprising writing an entry to a log if the first and second responses are semantically different.

8. The method of claim 1, further comprising storing an identifier in a first data structure associated with the first request and storing the identifier in a second data structure associated with the second request, the identifier serving to associate the first and second responses.

9. The method of claim 8, further comprising:
storing information derived from the second response in a third data structure;
in response to receiving the first response, searching the third data structure for the information; and
maintaining the information in non-volatile storage for subsequent use.

10. The method of claim 1, further comprising comparing data found on the first and second file systems for semantic equivalency.

11. A computer storage medium having computer-executable instructions, which when executed perform actions, comprising:
receiving a first request directed to a base driver, the base driver providing a reference regarding a response expected in response to the first request;
creating a second request for use in testing a first driver, the second request being semantically similar to the first request;
sending the first request toward the base driver;
sending the second request toward the first driver;
receiving a first response from the base driver;
receiving a second response from the first driver; and
comparing the first and second responses for semantic equivalency.

12. The computer storage medium of claim 11, wherein the first driver is a part of a driver stack that operates to access a virtual file system.

13. The computer storage medium of claim 11, wherein the first driver comprises a filter that operates to encrypt data on a file system.

14. The computer storage medium of claim 11, wherein the first driver comprises a filter that operates to attempt to prevent malware on a file system.

15. The computer storage medium of claim 11, wherein the first driver comprises a more recent version of the base driver.

16. The computer storage medium of claim 11, wherein the first driver monitors and logs activity regarding requests made to a file system, and wherein comparing the first and second responses is performed to ensure at least that the first driver does not corrupt data when the first driver logs the activity.

17. In a computing environment, an apparatus comprising:
a first driver operable to send requests to and receive responses thereto from a first driver stack;
a base driver operable to send requests to and receive responses thereto from a second driver stack; and
a parity filter operable to receives a first request from another entity, to create a second request from the first request, to send the first request to the base driver, to send the second request the first driver, to receive a first response to the first request from the base driver, to receive a second response from the first driver, and to compare the first response and the second response for semantic equivalency.

18. The apparatus of claim 17, wherein in being operable to create a second request from the first request, the parity filter is operable to create the second request such that the second request is semantically equivalent to the first request and such that the second request is formatted appropriately for the first driver.

19. The apparatus of claim 17, wherein the parity filter is further operable to write a log entry to a log if the first and second responses differ semantically.

20. The apparatus of claim 17, wherein semantic equivalency is defined by a set of one or more data values of the first and second responses.
